(19) United States
(12) Patent Application Publication
(10) Pub. No.: US 2017/0288496 A1
(43) Pub. Date: Oct. 5, 2017

(54) FRONT FLANGE OF A ROTARY ELECTRICAL MACHINE, AND ROTARY ELECTRICAL MACHINE COMPRISING A FLANGE OF THIS TYPE

(71) Applicant: VALEO EQUIPEMENTS ELECTRIQUES MOTEUR, Creteil Cedex (FR)

(72) Inventor: Gordaine PACCOU, Campagne Les Wardrecques (FR)

(21) Appl. No.: 15/472,592

(22) Filed: Mar. 29, 2017

(30) Foreign Application Priority Data
Mar. 30, 2016 (FR) 1652723

(51) Int. Cl. H02K 7/10

(52) U.S. Cl. CPC H02K 7/1008

(57) ABSTRACT

The front flange made of mouldable material of a rotary electrical machine with a pulley (1) for receipt of a belt comprises at least two projecting braces (70) with axial orientation obtained by moulding of its outer periphery, and designed for securing of a support of at least one body, such as a belt tensioning roller, the braces (70) each comprising laterally at least one hollow (71).

### CROSS-REFERENCE TO RELATED APPLICATIONS AND CLAIM TO PRIORITY

This application is related to Patent Application No. 1652723 filed Mar. 30, 2016 in France, the disclosure of which is incorporated herein by reference and to which priority is claimed.

### FIELD OF THE INVENTION

The present invention relates to a front flange made of mouldable material of a rotary electrical machine with a pulley for receipt of a belt.

The present invention also relates to a rotary electrical machine with a pulley for receipt of a belt comprising a flange of this type.

### BACKGROUND OF THE INVENTION

FIG. 1, which is a view in axial cross-section identical to FIG. 1 of document WO 2007/031679 shows schematically a conventional rotary electrical machine in the form of a reversible alternator, known as an alternator-starter, described for example in documents WO 01/69762 or FR A 2 745 444.

This machine comprises a housing 6, 8 made of mouldable material, such as housing made of aluminium or plastic material, an outer stator 5 provided with a body 50, conventionally a body in the form of a set of plates supporting a stator winding, and an inner rotor 4 which is integral with a rotor shaft 2 fitted such as to rotate in the housing with a hollow form.

The housing 6, 8 comprises at least two parts, i.e. a front flange 8 (on the drive pulley 1 side), and a rear flange 6, also known respectively as the front and rear bearings. This housing acts as a receptacle for the inner rotor 4, such as a rotor with permanent magnets, claws, or projecting poles. On its outer periphery, the housing supports the body 50 of the outer stator 5 fitted in particular by sintering in the housing. This housing comprises means such as lugs, ears, or a plate with holes, for securing of the electrical machine on a fixed part.

Each flange 6, 8 comprises centrally a receptacle in order to support a ball bearing (schematised by a rectangle with crosses) for fitting of the shaft 2 with rotation.

An air gap exists between the inner periphery of the body 50 of the stator 5 and the outer periphery of the inner rotor 4.

The stator winding can be of the multi-phase type, in particular at least of the three-phase type, passing axially through the body 50 of the stator, and extending projecting axially on both sides of the body 50, in order to form respectively front 51 and rear 52 chignons.

This winding comprises at least one winding per phase. The ends of the windings can be connected in the form of a star, as can be seen for example in FIG. 1 of document EP 0831 580, or in the form of a triangle. These ends can be connected to a bridge for rectification of alternating current into direct current, as described for example in document WO 02/093717, or to an inverter as described for example in documents EP 0831 580 and FR 2 745 444. Each winding can comprise a plurality of concentric coils which are connected to one another as described for example in document WO 2007/031679. As a variant, as described for example in document EP 0 881 742, the windings are constituted by continuous wires or conductive segments which are connected to one another by welding.

The body 50 comprises a strip of material which is known as a head, and a plurality of aligned notches, such as notches of the open or semi-closed type, which are aligned in order to form a plurality of axial grooves for fitting of the windings of the stator winding.

The rotor shaft 2 can be integral with the front of a pulley 1 belonging to a movement transmission comprising at least one belt (not represented) which intervenes between the rotary electrical machine and for example a thermal engine, such as the thermal engine of a motor vehicle.

In this FIG. 1, the pulley 1 and the belt are of the Poly-V (registered trademark) type. This pulley 1 with a hollow form comprises a base through which the rotational shaft 2 passes, with which it is integral in rotation for example by screwing and/or welding. The axial axis of symmetry XX of the shaft 2 constitutes the axis of rotation of the machine, the axis of the rotor 4 and of the stator 5. This shaft 2 leads to rendering integral, for example by force fitting of the rotor 4, in this case with claws, provided with an excitation winding which is implanted between two magnet wheels 27, 29 each of which is provided with teeth 45 with axial orientation imbricated as described and shown in document WO 02/093717.

The flanges 6, 8 have a hollow form, and are connected to one another by tie rods (with no reference) in order to form a housing which supports the stator 5 in its interior. The rear flange 6 supports a brush-holder (with no reference), the brushes of which are designed to rub on collector rings (with no reference) connected by wired connections to the inductor winding or excitation winding (not shown) which the claw rotor 4 comprises. Magnetic poles are formed, at the rate of one per tooth 45 of the magnet wheel 27, 29, when the rotor winding is supplied electrically. A protective cover (with no reference) surrounds the brush-holder as well as the sensor-holder (with no reference). This cover is integral with the rear flange 6.

It is important to cool the electrical machine, in particular the excitation winding of the rotor and its stator winding. For this purpose, cooling can be provided by means of an internal fan, the housing of which comprises air inlet and outlet openings, and at least one fan for circulation of the air between the air inlets and outlets.

In FIG. 1, the alternator comprises two fans, i.e. a fan 9 at the front of the rotor, and a rear fan 7, both of which are rendered integral with the rotor for example by welding. As a variant, the alternator could comprise a single fan, generally the rear fan 7 which is more powerful than the front fan 9 implanted on the drive pulley 1 side. A fan of this type comprises a flange from which there extends at least one series of projecting blades 8a, 7a. The fan 7, 9 is generally balanced by removing material from the rotor by means of drill bushes which form holes 25 in a drilling area 26 provided in the base 127 of at least one claw 45 of the rotor 4.

It is conceivable to equip a rotary electrical machine of this type with a device for adjustment of the tension of the belt, in order to prevent the belt from slipping and to optimise the movement transmission. A device of this type which uses a tensioning roller is described for example in patents AT 130902 and EP 0 459 894, to which reference will be made for further details.

In patent EP 0 459 894, the device for adjustment of the tension of the belt comprises a tensioning roller, an adjustable arm which is mobile in rotation relative to the front flange of the housing of the alternator, and means for maintenance and/or adjustment of the tension of the belt, such as a spiral spring or a rack and pinion device. The tensioning roller is fitted such as to rotate on the arm, advantageously by means of a ball bearing which is interposed radially between the inner periphery of the roller and a pivot, such as a bolt, which is integral with the front flange as described and shown for example in FIG. 2 of this patent EP 0 459 894.

In patent EP 0 459 894, the housing has a complicated form, taking into account in particular the fitting (not shown) to be carried out of the pulley. In addition, it is configured to constitute the support flange of the device for adjustment of the tension of the belt, the said flange also being used to secure the alternator on a fixed part of the motor vehicle.

Without changing the size of the rotor and the stator, it is conceivable to make the support of the device for adjustment of the tension of the belt distinct from the front flange, and to secure this support on the housing of the electrical machine, for example by means of at least two braces obtained when the outer periphery of the front flange is moulded.

These braces are subjected to substantial forces because of the presence of the tensioning roller, and are liable to break because of the presence of porosity during their production by moulding.

### SUMMARY OF THE INVENTION

The objective of the present invention is to make the braces more robust.

According to the invention, a front flange made of mouldable material of a rotary electrical machine with a pulley for receipt of a belt is characterised in that it comprises at least two braces with axial orientation obtained by moulding of its outer periphery, and designed for securing of a support of at least one body, such as a belt tensioning roller, the said braces each comprising laterally at least one hollow, which in particular is provided in the outer lateral wall of the brace 70.

Thanks to the invention, the braces are less porous and more robust. There is no excessive increase in the size and the implantation of the braces on the outer periphery of the front flange frees space for the pulley. The support can have the form of an arc of a circle, thus permitting the passage of the pulley and good circulation of the air inside the machine.

In addition, the means for securing the rotary electrical machine on a fixed part are not changed, since the braces are distinct from these means.

In addition, there is no increase in the consumption of material. More specifically, it would have been conceivable to connect the two braces by a bridge of material in order to make the braces more robust, but in this case the consumption of material and the weight of the machine are increased.

The number of braces depends on the applications and the forces transmitted by the support.

According to other characteristics taken in isolation or in combination:
the hollow extends in the direction in which the brace extends;
the hollow is provided in the outer lateral wall of the brace;
the hollow forms a circular segment on a plane orthogonal to the axis on which the brace extends;
the hollows are in the form of a cavity with a shallow depth;
the hollows are in the form of a cavity which extends along at least 80% of the height of the brace, and for example extends along the entire height of the brace;
the hollows have a length which is long in comparison with their depth;
the hollows have a rounded base, in particular in order to allow material to flow when the flange is moulded;
the hollows have a base in the form of an arc of a circle;
the hollows comprise a clearance angle;
the braces are in the form of a shaft;
a free end of at least one brace comprises a hole, which in particular is tapped, for screwing of the support;
a free end of each brace comprises a hole, which in particular is tapped, for screwing of the support;
the hollow is distinct from the hole in the free end of the brace;
the hole in the free end of each brace has a diameter of the M6 or M8 type;
on a plane perpendicular to the axis along which the brace extends, each hollow forms a circular segment, the height of which is at least equal to half the radius of the hole in the free end of the brace, for example at least equal to ⅔ of the radius of the hole, in particular at least equal to the radius of the hole;
a free end of each brace is in the form of a rivet for securing by riveting of the support of the said at least one body;
at least one of the braces comprises two hollows;
the front flange comprises at least two braces each comprising at least two hollows;
the front flange comprises three or four braces each equipped with at least two hollows;
the braces are distributed circumferentially in pairs according to an angle of between 30° and 100°, for example between 45° and 90°;
at least one of the braces comprises an opening in its outer periphery, in particular in order to allow material to be discharged during the tapping;
the said opening is implanted in the vicinity of the area of rooting of the brace on the body of the front flange;
the flange comprises a base which is extended at its outer periphery by a rim, with the said hollows extending axially from the free end of the braces to an area of rooting on the base of the flange;
the hollows extend axially from the free end of the braces to an area of rooting on the outer peripheral rim which the flange comprises;
the braces extend over at least 25% of the length of the pulley;
the housing is made of aluminium;
the housing is made of plastic material which is advantageously reinforced by fibres, such as glass fibres.

The invention also relates to a rotary electrical machine, in particular for a motor vehicle, comprising a pulley for receipt of a belt, characterised in that it comprises a front flange as previously described.

According to one embodiment, the machine comprises a rotor comprising an axis of rotation, and the hollow extends according to an axis parallel to the axis of rotation of the rotor.

According to one embodiment, the front flange is arranged on the axial side of the machine which comprises the pulley.

According to one embodiment, the machine comprises a tensioning roller which is secured on the front flange by means of braces.

According to one embodiment, the machine comprises securing screws for securing of the tensioning roller on the braces of the front flange.

According to one embodiment, the machine is an alternator-starter of a motor vehicle.

Other advantages will become apparent from reading the description which follows in a non-limiting manner, and with reference to the appended drawings.

### BRIEF DESCRIPTION OF THE DRAWINGS

FIG. 1 is a schematic view in axial cross-section of a rotary electrical machine according to the prior art;

FIG. 2 is a side view of a rotary electrical machine equipped with a front flange according to the invention;

FIG. 3 is a partial view in perspective of the pulley and of the front flange in FIG. 2;

FIG. 4 is a view similar to FIG. 3 without the pulley;

FIG. 5 is a partial front view of the front flange in FIGS. 2 to 4.

### DETAILED DESCRIPTION OF THE PREFERRED EMBODIMENT(S)

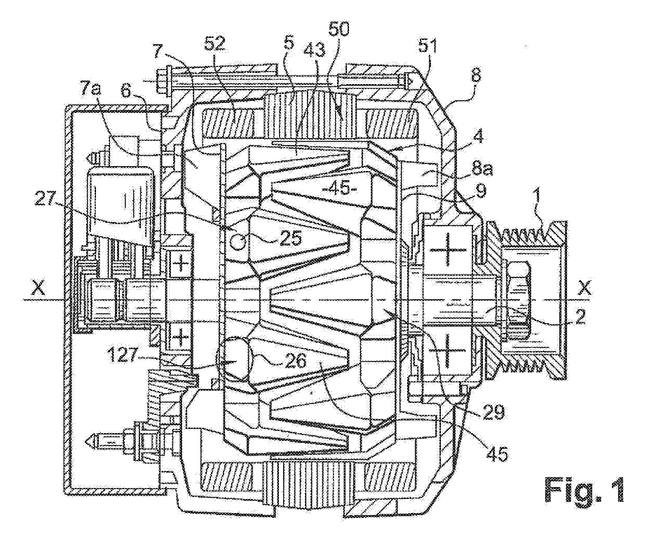

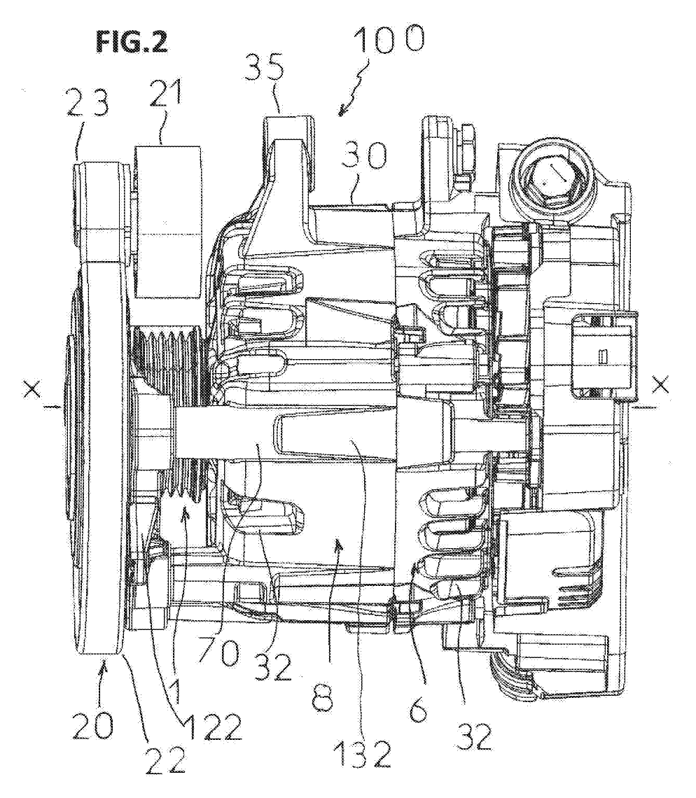

In the figures, elements which are identical or similar to those in FIG. 1 will be allocated the same reference numbers, and for the sake of simplicity FIGS. 2 to 5 represent only the elements which are necessary for understanding of the invention.

For the other internal elements of the machine, i.e. rotor shaft, ball bearing, stator, rotor, fans, brush-holder, sensor-holder, inverter, rectifier bridge, as applicable, reference will be made to the prior art and to FIG. 1, in the knowledge that the rotor of the machine can be a rotor with claws, a rotor with projecting poles, or a rotor with permanent magnets, and the stator winding can have concentric coils, as for example in document WO 2007/031679, or an undulating winding as for example in document EP 0 881 742. In FIGS. 2 to 5, the rotary electrical machine 100 is an alternator-starter with internal ventilation of the type in FIG. 1 and that described for example in document WO 01/69762 or document FR A 2 745 444, with an offset electronic casing. This alternator-starter thus comprises a pulley 1 which is integral with the rotor shaft with an axis X-X. The orientations axial, radial, circumferential and transverse will apply hereinafter with reference to the axis X-X which constitutes the axis of rotation of the machine 100, of the rotor and of the stator.

The housing 6, 8 of the machine 100 comprises at least two parts 6, 8, i.e. a front flange 8 and a rear flange 6 which are connected by tie rods. These flanges 6, 8 have a hollow form, and comprise centrally a receptacle for fitting of a ball bearing for rotation of the rotor shaft (see FIG. 1). It will be appreciated that, in a known manner, the housing of the machine can comprise an intermediate part between the flanges 6, 8 which supports the stator body. In FIG. 2, an orientation from front to rear corresponds to an orientation from left to right, and it can be seen that, like in FIG. 1, at the rear the machine comprises a protective cover with no reference which is integral with the flange 6.

The flanges 6, 8, which are also described in document WO 02/09371, are made of mouldable material, i.e. of aluminium in this example, and as a variant of plastic material which is preferably reinforced, for example with glass fibres.

These perforated flanges 6, 8 comprise openings for the air outlet 32 and inlet, for internal circulation of the air by means of a fan/fans integral with the rotor.

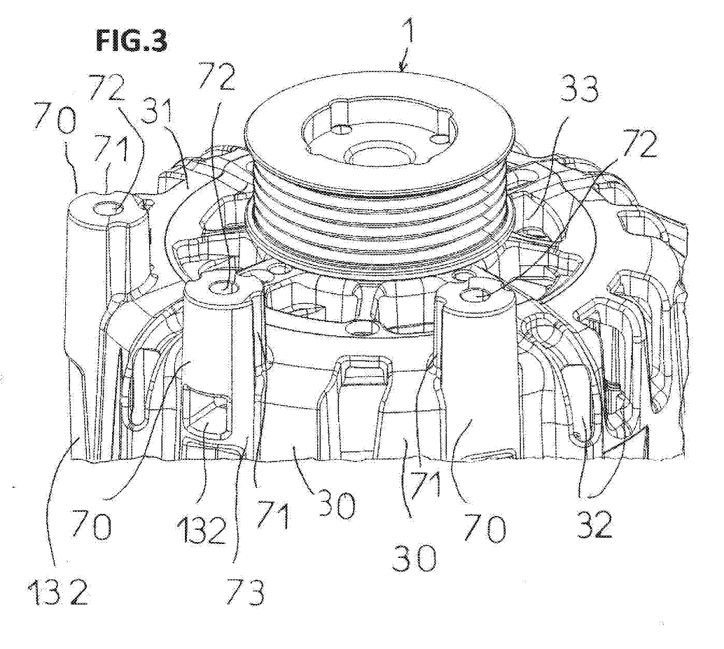

The air outlet openings 32 are mostly formed on the outer periphery of the flange 6, 8, more specifically in an outer peripheral rim, which has a globally cylindrical form and axial orientation, of the flanges 6, 8. The air inlet openings are formed in a base, in this case with globally transverse orientation, which the flanges 6, 8 comprise. The bases are connected on the exterior to the outer peripheral rims. Thus, as far as the front flange 8 adjacent to the pulley 1 is concerned, FIGS. 3 to 5 show at 31 the base, at 33 the air inlet openings, at 32 the air outlet openings, and at 30 the rim. The outlet openings 32 are obtained by removal from the mould, and consequently partly affect the base 31. FIG. 2 shows a securing means in the form of a securing lug 35, which the rim 30 of the front flange 8 comprises as a radial projection. This FIG. 2 also shows a securing lug, with no reference, of the flange 6. As a variant, the securing means are in the form of an ear, or are formed by means of a plate. In this example, the flange 8 also comprises a securing ear which is not shown.

This rotary electrical machine 100 with a pulley 1 for receipt of a belt is equipped at the front with a support 122 of a device 20 for adjustment of the tension of the belt. As in FIG. 1, the pulley 1 and the belt are of the Poly-V (registered trademark) type, the pulley 1 comprising grooves in order to receive the belt in a complementary manner.

As a variant, the belt 1 has a trapezoidal form, and the pulley 1 comprises a trapezoidal channel for receipt of the belt.

The device 20 comprises at least one body in the form of a roller for tensioning of the belt supported by the support 122. The body can be in the form of a dynamic tensioning roller.

According to one characteristic, the front flange 8 made of mouldable material comprises at least two projecting braces 70 with axial orientation obtained by moulding its outer periphery, and designed for securing a support 122 of at least one body, such as a belt tensioning roller, the said braces each comprising laterally at least one hollow 71.

Advantageously, at least one of the braces 70 comprises two hollows 71. The braces 70 are obtained partly from the outer periphery of the base 31, and partly from the outer periphery of the rim 30, in the manner described hereinafter. The braces 70 extend axially projecting in the direction opposite the base 31, constituting the front face of the flange 8 adjacent to the pulley 1.

As a result, the support 122 is distinct from the means 35 for securing the housing 6, 8 on a fixed part, and the porosity of the braces 70 is minimised, which makes the latter more robust. In addition, the size at the front face of the front flange is reduced since the support is distinct from the securing means 35.

The number of braces 70 depends on the applications and the forces to be withstood.

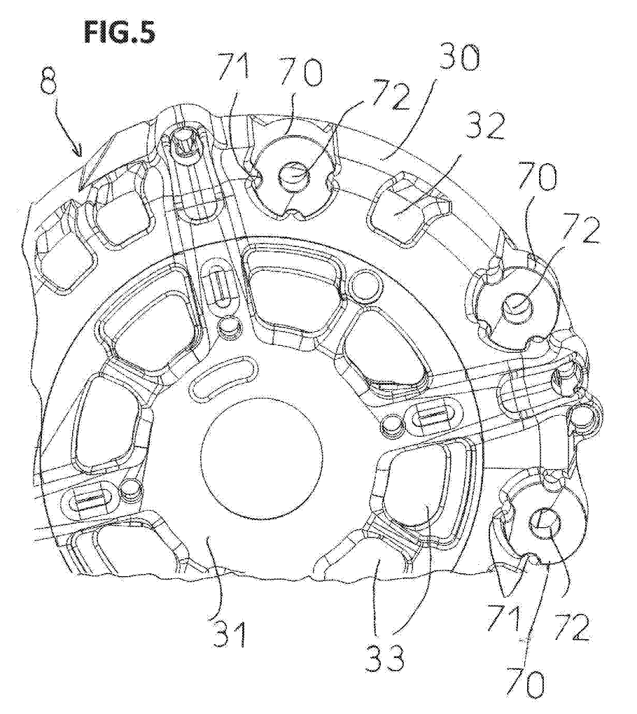

In this embodiment, three braces 70 are provided in order to secure the support 122 which is subjected to stress by the device 20. As can be seen in FIG. 5, two braces 70 are implanted circumferentially between two passages (with no reference) of the tie rods for assembly of the flanges 6, 8. In this example, three hollows 71 are provided by braces 70 with axial orientation. The number of hollows 71 can vary from 2 to 4 according to the size of the brace 70.

As can be seen in FIGS. 3 to 5, the hollows 71 are in the form of a cavity with a shallow depth. These hollows 71 have a length which is long in comparison with their depth.

The hollows 71 have a rounded base with a radius which is different from the radius of the flanks of the hollow 71 connecting the base of the hollow to the outer periphery of the brace 70. The braces 70 have a globally frusto-conical form for reasons of axial removal from the mould, the angle of the cone being small. Thus, the braces are in the form of a shaft.

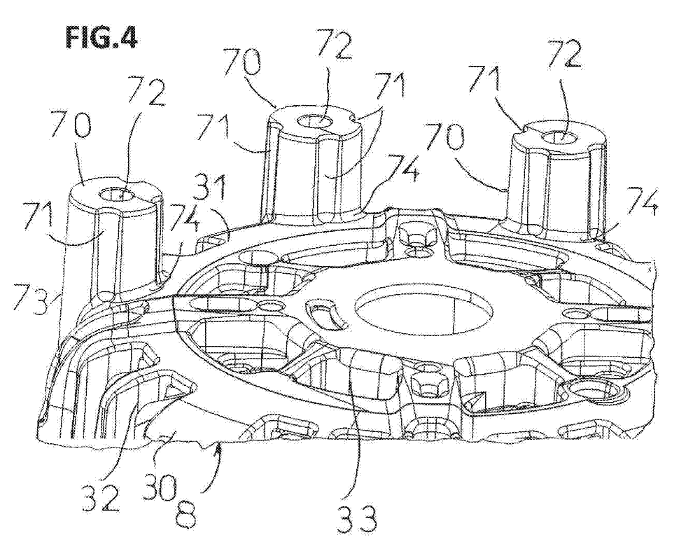

The hollows 71 extend axially from the free end 72 of the braces 70 at the base 31 of the flange 8. FIG. 4 shows at 74 the area of rooting of a brace on the outer periphery of the base 31. This area 74 is affected by the hollows 71. The reference 73 designates the area of rooting of a brace on the outer peripheral rim 30 of the flange 8. At least one of the braces 70 comprises on its outer periphery an opening 132 for discharge of air. This opening 132 is implanted in the vicinity of the area of rooting 73 of the brace 70 on the body of the flange 8. In this example, this opening 132 is implanted in the vicinity of the rim 30.

Advantageously, each brace 70 has an opening 132. The opening(s) 132 is/are implanted at the air outlets 32, and thus permit good discharge of the air.

The three braces 70 are distributed circumferentially according to an angle of more than 90° and less than 180°. Thus, the support 122 can have a form of an arc of a circle which extends radially on the exterior of the pulley 1. This support 122 permits the passage of the air through the air inlet openings 33. It will be appreciated that the braces are distributed on the outer periphery of the front face of the front flange 8 adjacent to the pulley 1, which makes it possible to clear a good passage between the support 122 and the pulley 1, without interference.

The braces 70 extend projecting on at least 25% of the length of the pulley 1.

The free end 72 of the brace in the form of a shaft is perforated and tapped for screwing of the support 122 of at least one tensioning roller. In this example, the support 122 is the support of the device 20 for adjustment of the tension of the belt comprising two tensioning rollers.

The adjustment device 20 comprises at least one tensioning roller 21 for adjustment of the tension of the belt, which in this case is implanted globally radially above the pulley 1. This device 20 is adjacent to the pulley 1, and extends projecting axially relative to the front end of the front flange 8. As is known, thanks to the device for adjustment of the tension of the belt, optimum tension of the belt is obtained, sliding of the belt is prevented, and there is filtering of the vibrations which can detract from satisfactory functioning of the rotary electrical machine, in the knowledge that these vibrations can break the securing means, such as ears or lugs or plates which the housing with a front flange has in order to be secured on a fixed part, such as the engine block of a motor vehicle. In this example, the device 20 comprises another tensioning roller which is supported by the support 122. The rollers are connected resiliently by a spring 22 with circumferential action, whilst being arranged laterally on both sides of the pulley 1. One of the rollers can be fixed, whilst being integral with the fixed support 122, whereas the other roller 21 can be displaced circumferentially under the action of the spring 22, whilst being supported by the support 122. Each roller is fitted such as to rotate by means of a pivot supported by an ear 23, preferably with intervention of a ball bearing between the inner periphery of the roller and the outer periphery of the pivot. The spring 22 is globally in the form of an omega, the ends of which are coupled to the ears of the rollers. The pivots, the ears and the rollers each belong to a coaxial part, one of which is constituted by the support 122. The part which supports the roller 21 is wedged in translation by the support 122, and is mobile circumferentially against the spring 22. These parts are thus supported by the support 122, and can be displaced circumferentially against the circumferential force exerted by the spring 22. For this purpose, the support 122 comprises at the front a hub which projects axially for fitting with rotation of the coaxial part comprising the pivot, the ear and the roller 21 belonging to the part which is mobile in rotation relative to the support 122.

As a variant, the two assemblies, each comprising a roller fitted such as to rotate on a pivot supported by an ear, each belong to a coaxial part which is fitted such as to rotate on the hub of the support 122, and wedged in translation by the said support 122. These parts can each be displaced circumferentially relative to the support 122, against the circumferential force exerted by the spring 22.

The presence of two rollers is justified by the fact that the rotor shaft is driven when the alternator-starter is functioning in alternator mode, in particular in order to charge the battery of the vehicle and supply its consumers electrically, whereas it drives when it is functioning in electric motor mode, in particular in order to start the engine of the vehicle.

According to one embodiment, the free end 72 of the braces 70 can have an outer diameter which is globally 20 mm, whereas the bases of the hollows 72 can be implanted on a diameter which is globally 16 mm, thus permitting good retention of the support 122. It will be appreciated that these dimensions depend on the applications and are given by way of indication.

This support 122 can comprise perforated ears opposite free ends 72 of the braces 70, for passage of securing screws screwed into the tapped holes of the free ends 72. The ears can be hollow and can cap the free ends 72. Good retention of the support 122 is thus provided.

The movement transmission belt can drive only the rotary electrical machine, via its pulley.

As a variant, the movement transmission belt can also drive another accessory, such as the compressor of an air conditioning installation. In this case, the thermal engine of the motor vehicle and the accessory each have a pulley for passage of the belt. For further details on the path of the movement transmission belt, reference will be made to FIG. 1 of document DE 102011082764 (EP 2 627 929 B), the two rollers being arranged laterally on both sides of the pulley. As a variant, the accessory with a pulley can be a water pump.

As a variant, the free end 72 of the brace 70 is in the form of a rivet for securing by riveting of the support 122 of at least one tensioning roller. This solution is easier to implement when, in the aforementioned manner, the front flange is made of plastic material, with the heads of the rivets being deformed by heat in order to provide the riveting. In all cases, the support 122 is perforated locally for passage of the screws for securing on the free ends 72 of the braces 70, or for passage of the rivets of the free ends of the braces 70 rooted on the flange 8.

The braces 70 and the hollows 71 are advantageously obtained by moulding of the flange 8 made of mouldable material.

As a variant, the base 31 of the front flange 8 is inclined. In this case, the flange comprises a nose for accommodation of the ball bearing for fitting of the rotor shaft with rotation.

As a variant, within the context of an alternator. The support 122 supports only one tensioning roller with intervention of a spiral spring, or a rack and pinion device as described in the aforementioned document EP 0 459 894.

The body which is supported by the support is not necessarily a roller.

As a variant, the front flange is not perforated, with the housing of the machine comprising a chamber for cooling of the machine for circulation of a heat transfer fluid, such as the cooling liquid of the thermal engine of a motor vehicle.

In these FIGS. 2 to 5, in addition to its function as a starter and its function of starting and stopping the thermal engine of the vehicle, depending on its power the alternator-starter can provide other functions, in particular in order to prevent the thermal engine from stalling.

As a variant, the alternator-starter is an alternator starter with integrated electronic components and a mezzanine, as described for example in documents WO 2006/129030 and WO 2004/040738.

As a variant:
the rotary electrical machine is an electric motor;
the electric motor drives at least one another accessory;
the rotary electrical machine is an electric motor without brushes and is controlled by an inverter as described for example in document EP 0831 580;
the electrical machine is a starter with a belt;
the rotary electrical machine is an alternator with a bridge for rectification of alternating current into direct current, for example of the type described in the aforementioned document WO 02/093717.

1. Front flange (8) made of mouldable material of a rotary electrical machine (100) with a pulley (1) for receipt of a belt, comprising at least two projecting braces (70) with axial orientation obtained by moulding of its outer periphery, and designed for securing of a support (122) of at least one body, such as a belt tensioning roller (21), said braces (70) each comprising laterally at least one hollow (71), which in particular is provided in the outer lateral wall of the brace (70).

2. Front flange (8) according to claim 1, wherein the hollows (71) are in the form of a cavity which extends along at least 80% of the height of the brace, and for example extends along the entire height of the brace.

3. Front flange (8) according to claim 1, wherein the hollows (71) have a rounded base.

4. Front flange (8) according to claim 1, wherein the braces (70) are in the form of a shaft.

5. Front flange (8) according to claim 1, wherein a free end (72) of each brace (70) comprises a hole, which in particular is tapped, for screwing of the support (122).

6. Front flange (8) according to claim 1, wherein at least one of the braces (70) comprises two hollows (71).

7. Front flange (8) according to claim 1, wherein three or four braces (70) are provided, each equipped with at least two hollows (71).

8. Front flange (8) according to claim 1, wherein the braces are distributed circumferentially in pairs according to an angle of between 30° and 100°, for example between 45° and 90°.

9. Front flange (8) according to claim 1, wherein at least one of the braces (70) comprises an opening (132) in its outer periphery, implanted in the vicinity of the area of rooting (73) of the brace (70) on the body of the front flange.

10. Front flange (8) according to claim 1, comprising a base (31) which is extended at its outer periphery by a rim (30), wherein the hollows (71) extend axially from the free end (72) of the braces (70) to an area of rooting (74) on the base (31) of the flange (8).

11. Rotary electrical machine (100), in particular for a motor vehicle, comprising a pulley (1) for receipt of a belt, comprising a front flange (8) according to claim 1.

12. Front flange (8) according to claim 2, wherein the hollows (71) have a rounded base.

13. Front flange (8) according to claim 2, wherein the braces (70) are in the form of a shaft.

14. Front flange (8) according to claim 3, wherein the braces (70) are in the form of a shaft.

15. Front flange (8) according to claim 2, wherein a free end (72) of each brace (70) comprises a hole, which in particular is tapped, for screwing of the support (122).

16. Front flange (8) according to claim 3, wherein a free end (72) of each brace (70) comprises a hole, which in particular is tapped, for screwing of the support (122).

17. Front flange (8) according to claim 4, wherein a free end (72) of each brace (70) comprises a hole, which in particular is tapped, for screwing of the support (122).
